(19) United States
(12) Patent Application Publication
(10) Pub. No.: US 2010/0296010 A1
(43) Pub. Date: Nov. 25, 2010

(54) DIGITAL PICTURE FRAME GREETING CARD

(76) Inventor: Dean Finnegan, Dublin, CA (US)

Correspondence Address: Vierra Magen Marcus & DeNiro LLP, 575 Market Street, Suite 2500, San Francisco, CA, 94105, US

(21) Appl. No.: 12/785,245

(22) Filed: May 21, 2010

Related U.S. Application Data
(60) Provisional application No. 61/180,419, filed on May 21, 2009.
(60) Provisional application No. 61/184,636, filed on Jun. 5, 2009.

(51) Int. Cl. H04N 5/64

(52) U.S. Cl. 348/794; 348/E05.128

(57) ABSTRACT

A multimedia device configured as a greeting card is provided with electronics a display of user configured pictures and sounds. Media storage is provided on the display. The device resembles traditional paper greeting cards.

### CLAIM OF PRIORITY

The present application claims priority to U. S. Provisional Application Ser. No. 61/180,419 filed May 21, 2009 and Application Ser. No. 61/184,636 filed Jun. 5, 2009, both of which are incorporated by reference herein in their entirety.

BACKGROUND

With the increasing popularity of digital photography, digital picture frames have become a popular means of displaying digital photos. Typically, a digital picture frame includes a display such as a liquid crystal display (LCD) having a display screen encased in a plastic or wooden frame made to resemble a printed picture frame. The surrounding frame is attached to the outside of the display, and is positioned at the front of the display so as to resemble a conventional picture frame housing displaying a printed picture.

Frames include a variety of additional features, including the ability to play music or other media files. Controls are provided to control the presentation of media within the frame.

Digital picture displays have been configured as key chains.

### BRIEF DESCRIPTION OF THE DRAWINGS

FIG. 1 depicts first perspective view of the greeting card display.

FIG. 2 illustrates a second perspective view of the greeting card display.

FIG. 3 illustrates a third view showing internal components of the greeting card display

FIG. 4 rear perspective view of the greeting card display.

FIG. 5 is a block diagram of the internal components of the greeting card display.

FIGS. 6 and 7 are perspective views of an alternative embodiment of the greeting card display utilizing a card reader.

FIG. 8 illustrates another alternative embodiment of the greeting card display.

FIG. 9 is a flowchart illustrating an exemplary operating sequence.

FIG. 10 illustrates an additional embodiment of the apparatus.

FIG. 11 illustrates a perspective, open view of another embodiment of the greeting card display.

FIG. 12 illustrates a perspective, end view of the embodiment of FIG. 11.

FIG. 13 illustrates a perspective, side view of the embodiment of FIG. 11.

FIG. 14 is a perspective view of the display module.

FIG. 15 is an alternative configuration of the greeting card display.

FIG. 16 is a method of operation for the alternative greeting card display of FIG. 15.

FIG. 17 is a user interface operating on a processing device used to interface with the greeting card of FIG. 15.

### DETAILED DESCRIPTION

A multimedia device configured as a greeting card is described. The greeting card is provided with electronics for driving the display with user configured pictures and sounds. Media storage is provided on the display and in one embodiment, portable storage may be used to add storage to the display. The greeting card resembles traditional paper greeting cards but provides additional functionality allowing for multimedia displays therein.

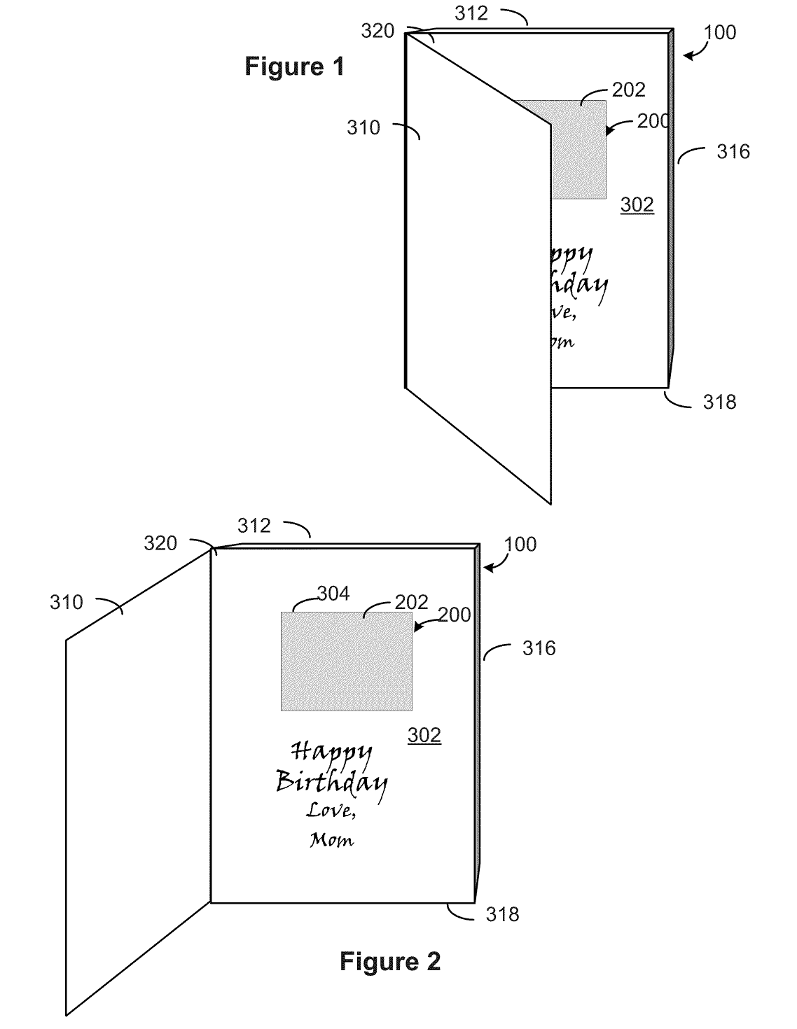

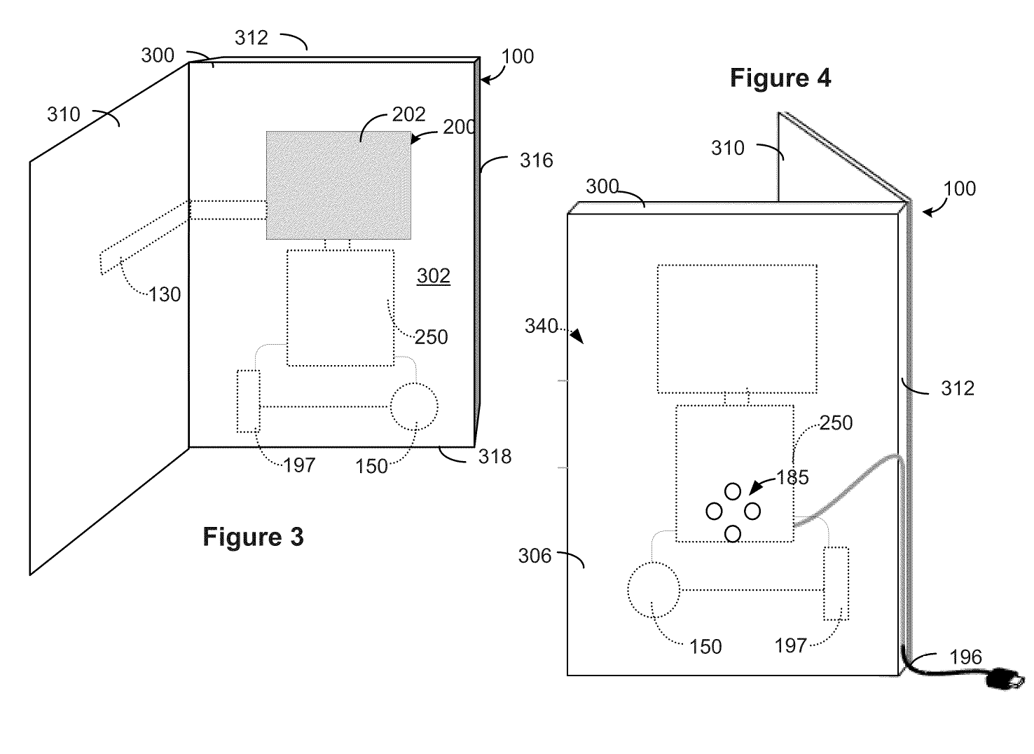

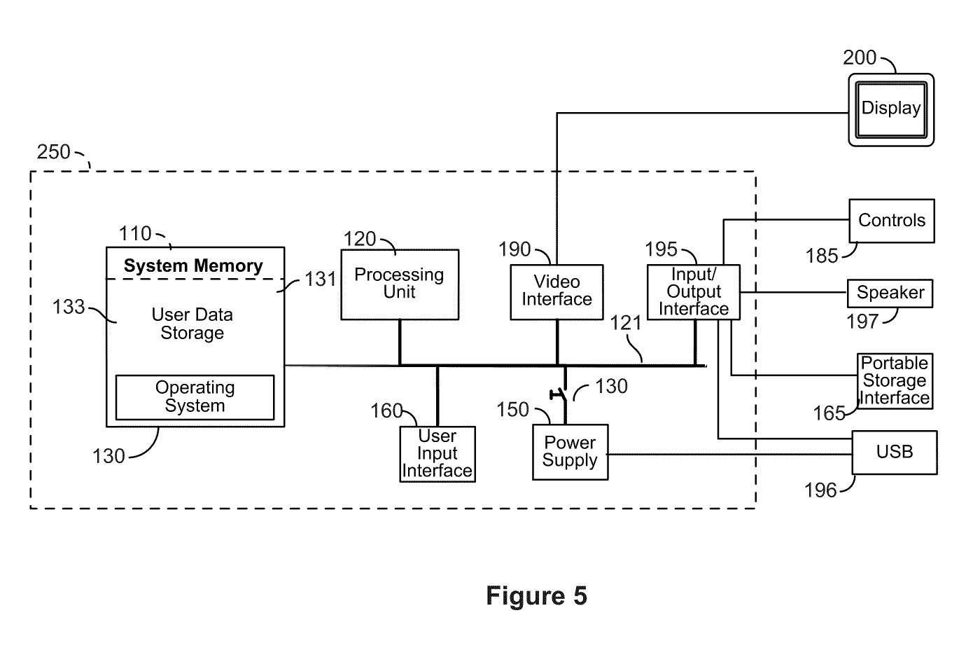

FIGS. 1-5 show a first embodiment of the multimedia display apparatus 100 in the form of a greeting card that includes a display 200 surrounded by a card element 300. The card element 300 includes a base portion 320 and a flap 310. The base portion includes a top edge 314, bottom edge 318 and side edges 312 and 316. The base portion 320 includes a surface 302 in which a front portion 202 of the display 200 appears through a window 304. A front flap 310 coupled to base 320 is illustrated in a partially open condition in FIGS. 1 and 3, and a partially closed condition in FIGS. 2 and 4. The display 200 is mounted in the base portion 320 in an interior cavity 340 formed between surface 302 and a rear surface 304 in the base 320. The base portion comprises a display housing including the display 200, and a printed circuit board 250 including components identified in FIG. 5, including a power source 150 and a speaker 197. Flap 310 is attached to edge 312 in a manner allowing it to fold over the surface 302 to completely cover surface 302.

Display 200 is secured in the base 320 by the use of glue, adhesive or other similar means. Frame element 300 may be made from any number of suitable materials, including paper, cardboard, compressed paper, plastic or wood, and may be configured to resemble an greeting card.

Display 200 comprises, for example, a liquid crystal display (LCD), a passive display, an active display or any other known display technology. The display 200 is also generally referred to as a flat panel display. It will be understood that the display 200 may be available in a plurality of sizes and shapes. Base 320 and flap 310 may be manufactured from various weights of paperboard, plastic or other materials designed to resemble the construction of a greeting card. In one embodiment, the material used allows an individual to write a personal greeting on the card using a writing instrument in much the same manner one writes on a greeting card, as illustrated by the words “Happy Birthday, Love Mom” in FIG. 2.

A switch 130 which may comprise a metallic strip with a first portion embedded in the face 320 and a second portion in flap 310 controls the display functions of the device. Instructions provided in the PCB may enable the display functions of the device when a user activates the switch by opening the card, and disable the display functions of the device when a user closes the card. Optionally, one or more function control buttons 185 (illustrated in FIG. 4) may be provided on or near the display 200 to allow a user to control more sophisticated display options in the display device.

FIG. 5 illustrates an example of internal components of a media apparatus 100. The apparatus 100 may include circuitry 250 to display and perform various types of media including images, sounds and/or movies on the face, and sounds via built in speakers 197. Circuitry 250 is provided in the housing to render display media on the face of the device. A power source 150 in the form of a battery, rechargeable battery or power supply is provided for display apparatus 100. Power source 150 may be an AC/DC converter which accepts power from the connector cable 196.

A connection cable 196 may comprise a universal serial bus (USB) cable or mini-USB cable, is connected to the circuit board to provide both power and data communications to the elements on the board. In one embodiment, the cable 196 is hidden within the inner cavity 340 and exits the cavity along side 312. The connection cable may include a power channel, enabling dc or ac power to the device 100. Cable 196 may include data channel, which allows a computer or other processing device to connect to the apparatus and install user data and/or provide display instructions.

As illustrated in FIG. 5 display apparatus circuitry 250 may include a processing unit 120, a system memory 110, a video interface 190, input/output interface 195 and a system bus 121 that couples various system components including the system memory to the processing unit 120. The system bus 121 may be any of several types of bus structures. System memory 110 may be divided into non-volatile and volatile memory, and include user data storage 133, an operating system 133 and operating memory 131.

System memory 110 includes at least a basic operating system 130 with code for instructing processing unit 120 to provide decoding of image and sound data files store in user data storage 133. An operating system 130 may provide basic input, output, storage and display functions responsive to a control signal from a connected processing system. In one embodiment, internal non-volatile memory 133 may be included to allow a user to store media within the display device.

In one embodiment, the operating system includes instructions to store user data in system memory when a computing device couples to the apparatus 100 via the connector cable 196 and basic playing instructions for the data. In an alternative embodiment, operating system 130 may provide a user with an interface displayed on the display 200 and allow control for transferring user data to the system memory, as well as displaying media files, through on-board controls 185. In accordance with this embodiment, a user may couple the apparatus 100 to a computer via the connection cable 196. Generally, most computer operating systems include the ability to recognize devices coupled via a USB interface as a memory storage location and can transfer user files to the location via the connection cable. System memory 110 may be of any sufficient size to enable a user to store user data within the user data storage area of system memory 110. User data may comprise image files, audio files, and other types of multimedia files.

In one embodiment, multimedia files capable of display on the device include any number of audio, video and image encoded formats. Instructions may be provided for the processing unit enabling the processing unit to decode any of such formats and drive the video display of such formats on the video output. Alternatively, decoding and audio and video driving instructions may be provided in a dedicated programmed hardware processor.

Once data is transferred to the user data storage 133, in one embodiment, instructions enabled by the stitch 140 begin an ordered display of the media stored on the device. If, for example, a user has stored three image files A, B, and C and two audio files, D and E, the instructions may respond to the “card open” signal provided by the switch. Additional control functions maybe provided by allowing a computing device coupled via cable 196 to control functions on the device 100.

In another embodiment, a user interface on the display 200 is generated by the operating system and input received via the user input interface 160. The user interface is displayed in the display area 210 on the face 215 that provides a user various options for displaying media, including determining the source of the media, the order of the media display, and whether music accompanies the display, for example. The interface may include providing a series of user menus and prompts providing the user with access to control a number of functions that the device can perform. For example, one set of instructions may provide a slide-show interface allowing the user to select a series of pictures for sequential or random display, each for a period of time on the display. Any of a number of prompts and/or menus can be utilized to provide such control functionality. In addition, plug-in non-volatile memory interfaces may be included and read by portable memory reader 165 to allow the user to utilize well know formats of non-volatile memory such as Compact Flash or Secure Digital card memory to interface with the control circuitry. In this way, photos or images downloaded from a digital camera, the Internet, computer or other device can be stored on a given format, for example TIFF, PDF, JPG, etc. and displayed on display face 215.

A user input interface 160 may optionally be provided to allow direct user input to the device via a series of control buttons (165). A user may enter commands and information into the device 100 through input device hardware buttons 185.

In yet another embodiment, the operating system includes code for implementing the process of FIG. 9. At 902, the card display and display operation is activated when the card face is opened such as when the face 310 is moved away from body 320. If control buttons 165 are activated by the user, a control menu 920 may be displayed on display face 202. The control menu may provide the user with additional functions including ordering the media display, or allowing the user to select from a series of pre-defined, stored media to accompany the display of the user's own media. If this is the first time the card has been opened at 906, the instructions will prompt the user for connection to a computer or for the insertion of a memory card from which to load media into the card display. In one embodiment, pre-stored media may be provided. At 910, pictures are loaded on the device from the user connection or from the memory card. At 912, optionally, the user may be prompted to pick a display sequence for the media, or to choose, for example, to display images in conjunction with audio files concurrently or separately. This allows a user to provide different types of media files and to play the files in differing order to personalize the experience of the recipient. In one embodiment, a microphone may be incorporated into the card and recording instructions provided to allow the user to record a personalized greeting to accompany media loaded onto the apparatus 100.

At 914, the user confirms the sequence chosen is correct.

At 916, when the user opens a card 902 and it is not the initial powering on of the card, the media is displayed until the card is closed at 918. The process will be repeated until the user activated the control buttons at 904 to alter the display process.

A display 200 is also connected to the system bus 121 via an interface, such as a video interface 190. The video interface 190 provides an output to the display 200. The I/O interface 195 enables connection of other transport technologies such as Universal Serial Bus storage devices and IEEE 1394 storage devices. Speaker 197 may also be coupled to the I/O interface 195.

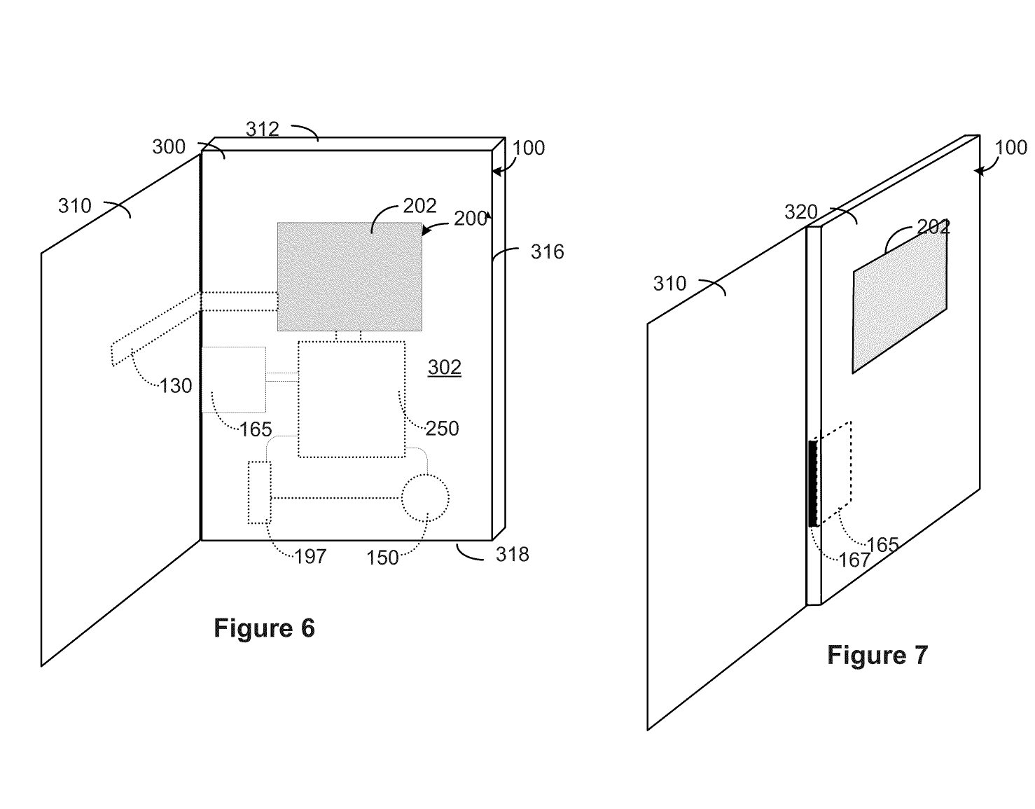

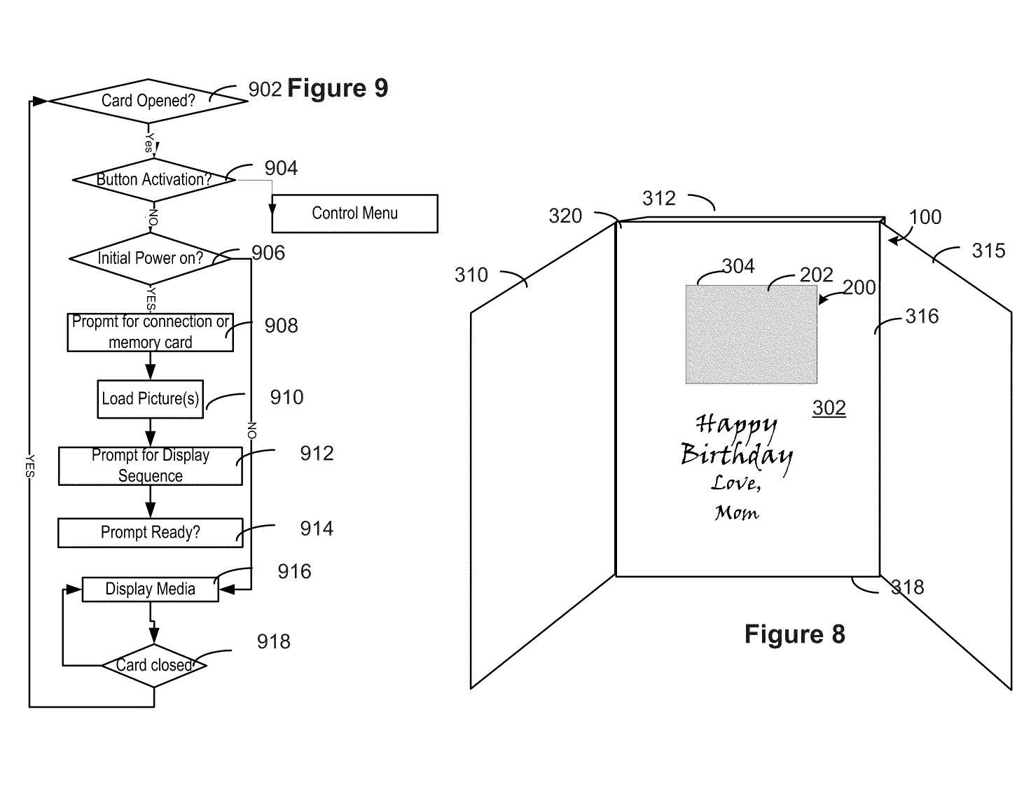

FIG. 6 illustrates a second embodiment of the apparatus where a portable storage device reader 165 is utilized. In this embodiment, the card reader is positioned so that an opening 167 is provided in a crease between edge 310 and body 320. Any manner of card reader may be utilized. Card reader 165 is coupled to PCB components 250.

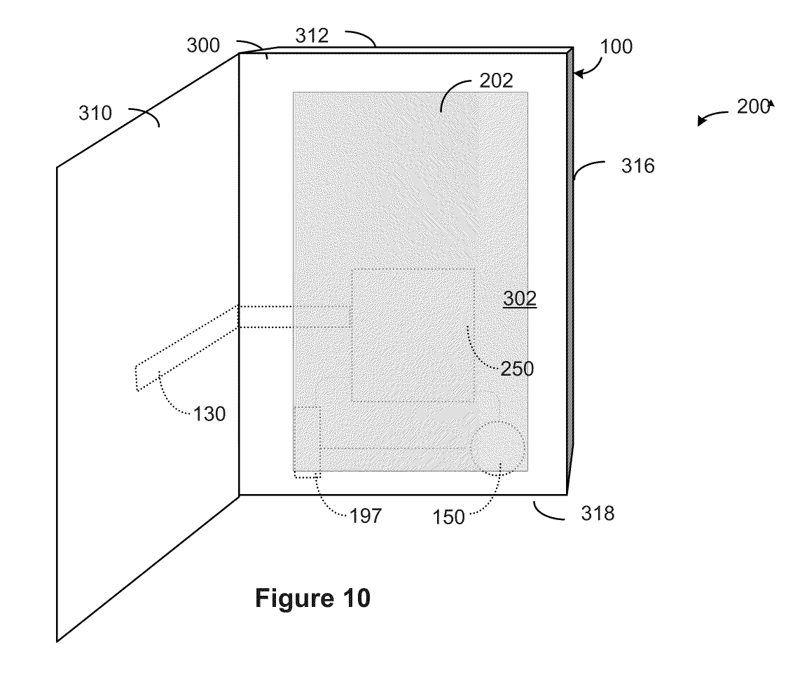

FIG. 9 illustrates yet another embodiment of the apparatus including a third side 315 coupled to side 316 of body 310. FIG. 10 illustrates a card display apparatus having a larger display size than that of the previous embodiments. It should be understood that the display apparatus may have any number of variants on the size and shape of the display in conjunction with the card housing.

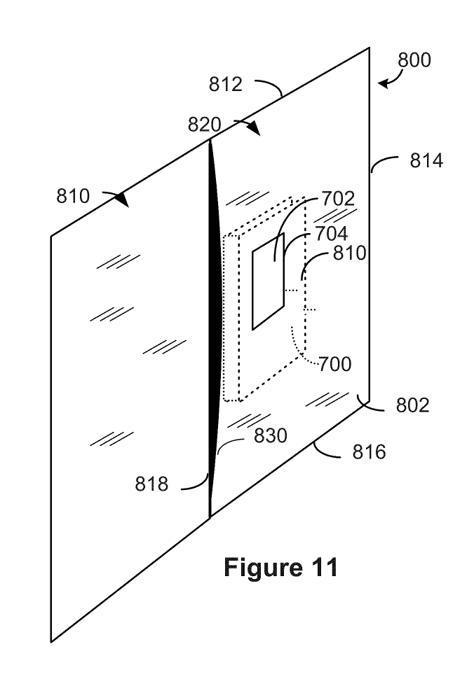

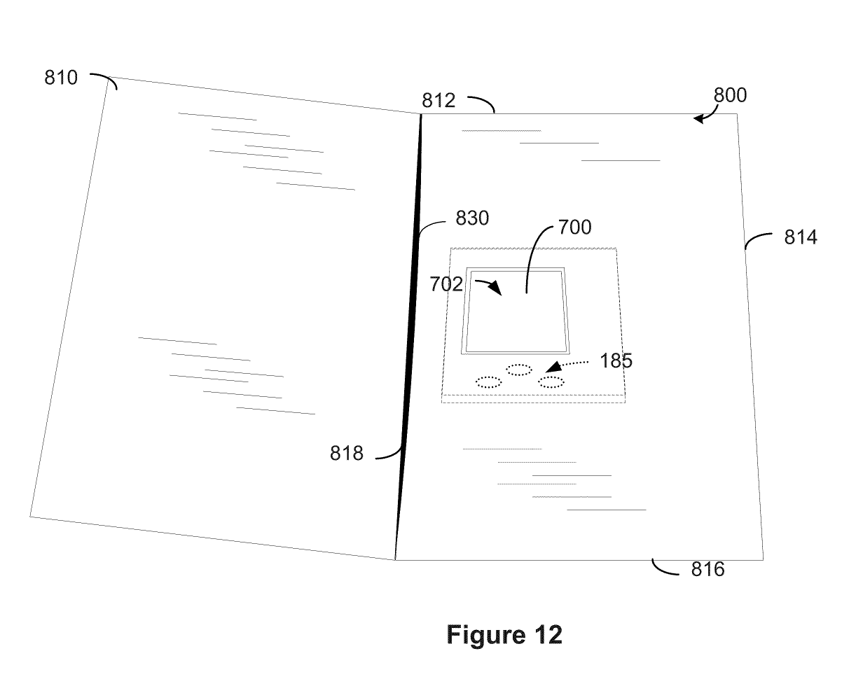

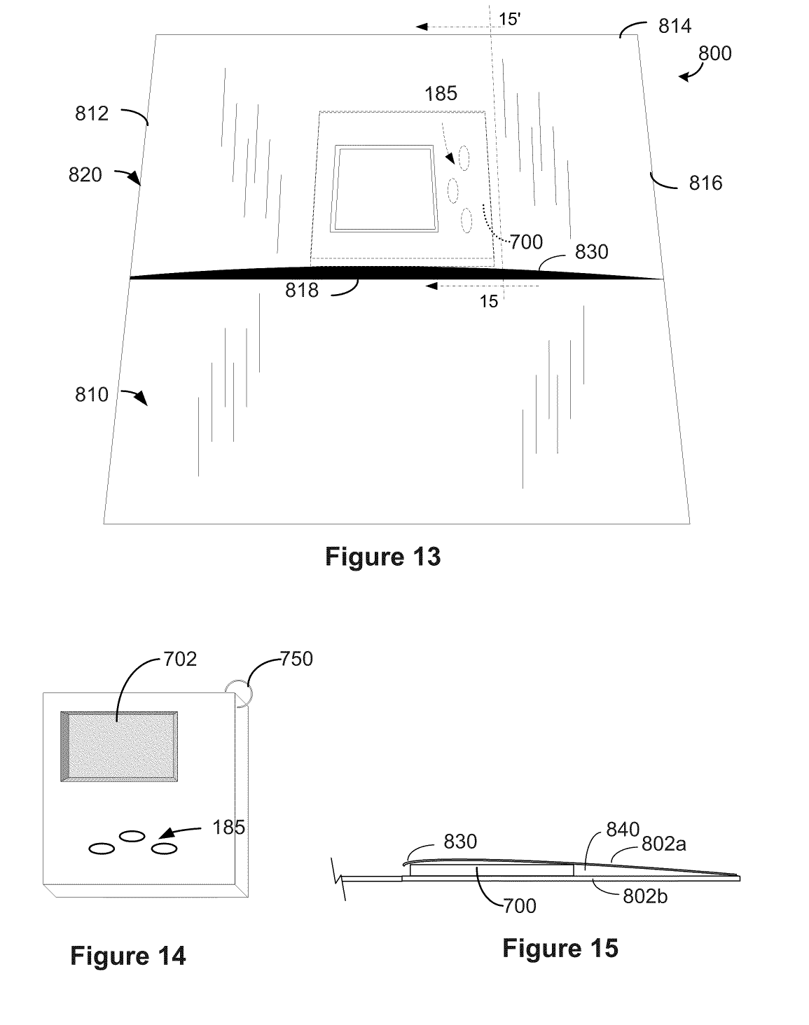

FIGS. 11-14 illustrate yet another embodiment of the greeting card display apparatus formed in accordance with the present technology. The embodiment of FIGS. 11-14 provides a sleeve for a display module in the form of a greeting card, the sleeve allowing a self-contained module to display media while in the card, and to be removed for use in other operations.

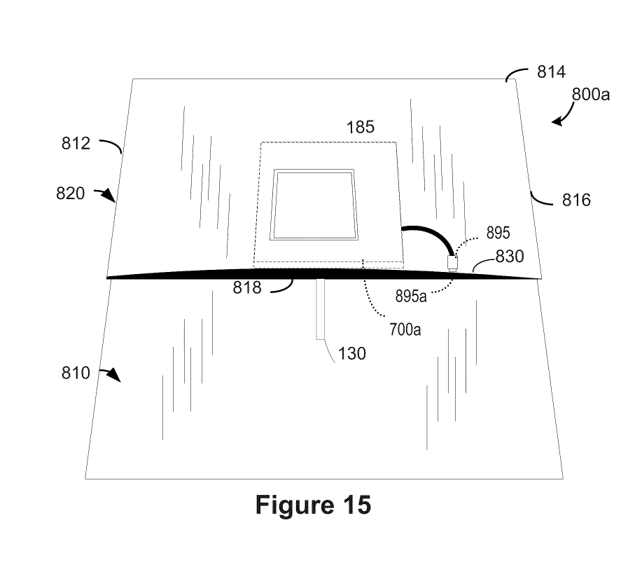

A display 700 module surrounded by a card element 800. The card element 800 includes a base portion 820 and a flap 810. The flap 810 closes over the base at edge 818. The base portion includes a top edge 812, bottom edge 816 and side edges 814 and 818. Edge 818 may be a fold between the flap 810 and a base surface 802b, described below. The base portion 820 includes a surface 802a in which a front portion 702 of the display 700 appears through a window 704. A front flap 810 coupled to base 820 is illustrated in an open condition in FIGS. 10-14. Front surface 802 is formed by joining a first surface 802a to a rear surface 802b (FIG. 15). The surfaces can be joined by folding one edge (814) and gluing or otherwise fastening two edges (812, 816), or gluing three edges of surface 302a to surface 302b. One edge 830 of surface 802a is separated from edge 802b creating a cavity 840 between the surfaces 802a, 802b, bounded by edges 812, 814, 816. The display 700 is mounted in the cavity in base portion 320 in an interior cavity 340 formed between surface 302 840.

The display module 700 includes a printed circuit board 250 including components identified in FIG. 5, including a power source 150 and a speaker 197. Activation and control buttons 185 allow control of the display module in the manner described above. It will be recognized that the methodology of FIG. 9 may be employed without steps 902 requiring activation of the display by opening the card.

Display module 700 may be comprised of a plastic casing surrounding the components illustrated in FIG. 5 or a subset thereof. The components may be powered by a 3.7V, 100 mAh rechargeable battery or 2 button batteries. In one embodiment, a mini-USB or other suitable connector allows connection of the module to a computer to allow pictures and other media to be downloaded to the module. Picture download can be achieved by using a small UI program upon USB cable is connected to the computer, or natively using the operating system of the computer to which the module is connected.

In one embodiment, a user can attach a voice recording to each and every picture if the user wishes. Where the user data storage is 2 MB memory, a user can download approximately 50 pictures, each with voice recording attached.

A hook 750 is provided on the module 700 (FIG. 14) that allows connection of the module 700 to, for example, a keychain or other connector. In one embodiment, the module 700 has dimensions of about 50 mm×80 mm×5 mm.

FIGS. 15-17 illustrate yet another embodiment of a multimedia display apparatus formed to appear as a greeting card. Apparatus 800A includes a display module 700a which, in this embodiment, is provided without exterior controls. A switch 130 enables power to the display module from the power source (shown in FIG. 5). In this embodiment, a connector for a processing device may comprise a female micro USB connector 895, provided with an end 895a adjacent edge 830 to allow the display module 700a to connect to a processing device such as a computer. Display element 700a may include all of the components illustrated in FIGS. 3 and 5, but in one implementation may not include controls 185, speaker 197 and portable storage interface 165.

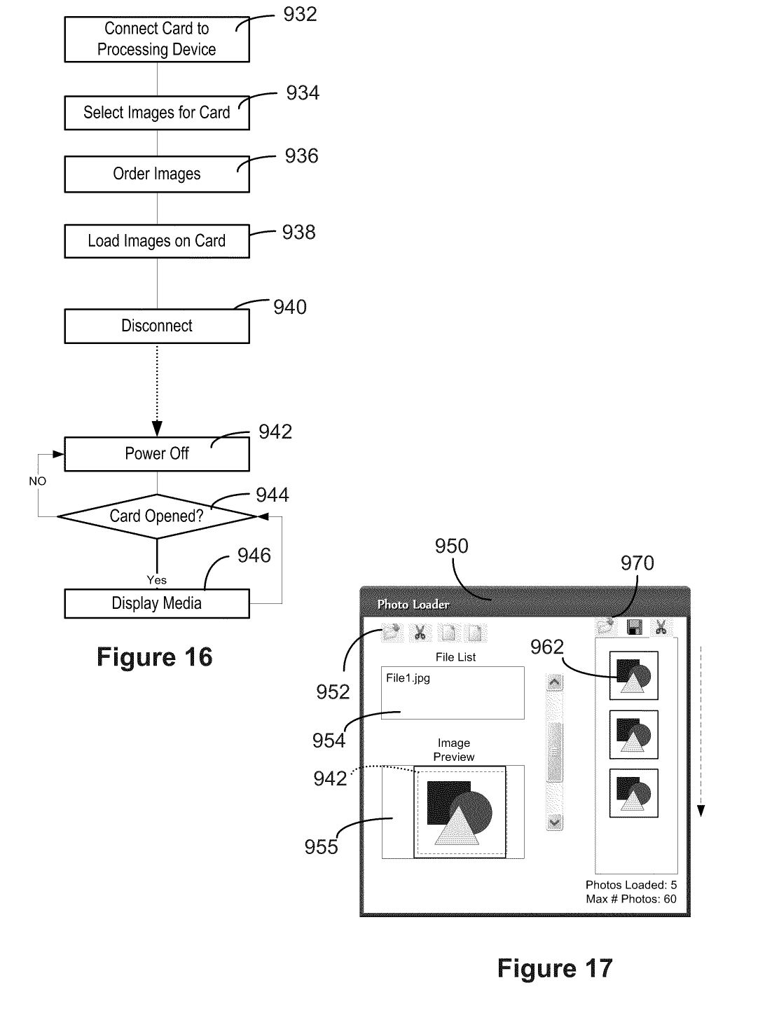

As noted above, images may be loaded onto the display module 700a by enabling display module 700a to be recognized as a read/write drive when connected to a computer. In another embodiment, images are loaded onto the internal memory 133 of module 700a using the method of FIG. 16 and control software having an interface such as that shown in FIG. 17. FIG. 17 represents a user interface enabled by code for instructing a processing device to provide the functional elements described below on a general purpose computer in an application running on the processing device.

A user may connect the card element 800A to the processing device at 932. To do so, the user must place the card in an open position as shown in FIG. 15. In the open position, power from the power source 130 shown in FIG. 2 enables components of the display element 700a. Once connected, power may be supplied from the processing device via the connector. As noted above, the power source may be a rechargeable battery and power is supplied from the processing device is used to recharge the battery. When connected, power from processing device can be used to directly power the elements shown in FIG. 2 to allow pictures and other media to be loaded on the card element.

Once a card is connected at 932, at 934 a user may select images for installation into the display device 800A. Images may be stored on the processing device. In one embodiment, the interface 950 includes a file list window 954 allowing users to add files or directories of files, to a list which the application uses to allow a user to select files at 934. Images can be selected in the file list window and when selected may appear in a preview window 942. The preview window allows re-sizing, editing and cropping of a selected image. When editing is completed, the user can select to add the edited figure to the device 700a. Images selected for addition to the card, or already present on the card, appear in a selection and ordering window 962. The top to bottom order of images in window 970 may represent the order that the images will appear in sequence on the device 700a. A user may drag and drop images in window 962 to change the order of the images and the resulting display order on the display module 700a, at step 936.

Once a user has completed selection and ordering of the images at 934 and 946, images may be loaded onto the card element at 938. This may comprise selecting an interface element such as a button which invokes an instruction in the software to load the images onto the display element 700a. Once images are loaded, the card element is ready for user. Steps 932-940 may be repeated any number of times before step 942. In addition, images may be removed from the card by a similar sequence.

At 942 the card remains in a powered off state while the lid of the card is closed. When the card is opened at 944, the card will be powered on and the images displayed in the sequence defined in the software as described above. As such, device 800a has a simple mode of operation, and the customizations provided by the user are generally ensured to play in their intended sequence since no card based controls are accessible to the view of the card without a connection to a processing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A display apparatus, comprising:
a housing comprising a greeting card comprised of a paper material, the housing having a front face and a base including a cavity, the front face joined to the base along a common edge;
a display element provided in the base, the display element having a connector, the display element including a display face and circuitry to display images on the display face.

2. The display apparatus of claim 1 further including a power source and a switch coupled to the power source, the power source enabling the circuitry when the front face is opened away from the base along the common edge thereby closing the switch.

3. The display apparatus of claim 2 wherein the connector is a USB connector.

4. The display apparatus of claim 2 wherein the power source is a rechargeable battery and power is provided to recharge the battery via the connector.

5. The display apparatus of claim 1 wherein the display element includes a plurality of external controls.

6. The display apparatus of claim 1 wherein the display apparatus includes a plurality of images and the circuitry includes code for displaying the images in an order defined by the user upon supplying power to the display element.

7. The display apparatus of claim 1 wherein the display element includes:
A processing unit;
A video interface;
A speaker;
A portable storage interface; and
User data storage.

8. The display apparatus of claim 1 wherein the housing is comprised of paper.

9. The display apparatus of claim 1 wherein the display face comprises an LCD display.

10. A greeting card multimedia display apparatus, comprising:
a housing comprising a greeting card comprised of a paper material, the housing having a planar front face and a planar base, the front face joined to the base along a common edge between the front face and the planar base;
a display element provided in the base, the display element including an LCD display face, an image processor, and memory storing at least one image, the display element including code displaying the image on the LCD display face;
a power source coupled to the display face, image processor and memory; and
a switch coupled to the front face and the power source, the switch connecting the power source and the display face, image processor and memory when the front face is moved away from the base along the common edge thereby indicating an opening of the card.

11. The display apparatus of claim 10 wherein apparatus further includes a connector comprising a USB connector.

12. The display apparatus of claim 11 wherein the power source is a rechargeable battery and power is provided to recharge the battery via the connector.

13. The display apparatus of claim 12 wherein the display element includes a speaker and code for playing one or more audio files via the speaker.

14. The display apparatus of claim 13 wherein the display apparatus includes a plurality of images and the circuitry includes code for displaying the images in an order defined by the user upon supplying power to the display element.

15. A method of displaying images, comprising:
Providing a display apparatus including a housing comprising a greeting card comprised of a paper material, the housing having a front face and a base including a display element, a power source coupled to the display element, the front face joined to the base along a common edge, a switch provided in the front face and the base, the switch connecting the power source and the display element;
Receiving power upon a closing of the switch by movement of the front face away from the base;
Upon receiving power, automatically displaying a plurality of images stored in the display element in an order defined by a user;

16. The method of claim 15 further including the step of receiving one or more of an audio file or a video file and said automatically displaying includes automatically displaying the audio or video file.
